(19) United States
(12) Patent Application Publication
(10) Pub. No.: US 2025/0140906 A1
(43) Pub. Date: May 1, 2025

(54) DEFORMABLE HALIDE IONIC CONDUCTORS FOR USE AS ANOLYTES, SOLID ELECTROLYTES OR CATHOLYTES IN SOLID STATE BATTERIES

(71) Applicant: SAMSUNG ELECTRONICS CO., LTD., Suwon-si (KR)

(72) Inventors: Valentina LACIVITA, Cambridge, MA (US); Yan WANG, Brookline, MA (US); Yongwoo SHIN, Concord, MA (US); Samuel Robert CROSS, Cambridge, MA (US)

(73) Assignee: SAMSUNG ELECTRONICS CO., LTD., Suwon-si (KR)

(21) Appl. No.: 18/440,484

(22) Filed: Feb. 13, 2024

Related U.S. Application Data
(60) Provisional application No. 63/548,475, filed on Nov. 14, 2023.
(60) Provisional application No. 63/546,793, filed on Nov. 1, 2023.

(51) Int. Cl. H01M 10/0562; C01D 15/00; C01D 17/00

(52) U.S. Cl. CPC H01M 10/0562; C01D 15/00; C01D 17/003; C01P 2002/76; C01P 2002/90; C01P 2006/40; H01M 2220/20

(57) ABSTRACT

An anolyte includes a deformable halide-based ionic conductor having one of the following formulas: CsLi₂Cl₃, wherein the CsLi₂Cl₃ has an orthorhombic crystal structure, NaLi₃I₄, NaLi₃Br₄, NaLi₃Cl₄, and KLi₂F₃. A solid state battery includes an anode, a cathode, and a solid electrolyte, wherein the solid state battery comprises the aforementioned anolyte.

### CROSS-REFERENCE TO RELATED APPLICATION

This application is based on and claims priority from U.S. Provisional Application No. 63/546,793 filed on Nov. 1, 2023 and U.S. Provisional Application No. 63/548,475 filed on Nov. 14, 2023 in the U.S. Patent and Trademark Office, the disclosure of which is incorporated herein by reference in its entirety.

### BACKGROUND

### 1. Field

Materials according to embodiments relate to ionic conductors for use as anolytes, catholytes or solid electrolytes in Li solid-state batteries.

### 2. Description of the Related Art

The field of battery research is in the midst of a paradigm shift from conventional liquid electrolyte systems to all-solid-state batteries (SSBs) with solid state electrolytes (SEs), owing to their high safety and potentially large volumetric energy density by enabling both the use of lithium metal anodes and the bipolar stacking of electrodes.

This transition brings a significant change in the kinetics of interfacial electrochemistry governing the battery performance because of the rigid solid-solid interface between active materials and SE in SSBs. In a typical liquid electrolyte cell, the active material surface is completely covered by the fluidic electrolyte, whereas a solid electrolyte forms a point contact with the active material due to its intrinsically rigid nature, thereby inducing sluggish charge transfer and mass transport kinetics at the interface. Thus, to achieve SSBs, an important prerequisite is forming and maintaining a well-defined solid-solid interface with intimate contact between the SE and cathode/anode active materials during electrochemical cycling.

Recently, halide ionic conductors, particularly chlorides, were raised as a promising class of solid electrolytes. They are ionically conductive and easily deformable like sulfides, but they do not suffer from the same poor oxidative stability of sulfides. The oxidation potential of chlorides and fluorides is generally much higher (comparable to oxides), leading to an excellent compatibility with 4V-class cathodes.

However, there are problems with some embodiments, including the following:
A core issue of SSBs is the mechanical, chemical, and electrochemical compatibility of SEs with electrodes. Non-conformal contact at the electrode-electrolyte interface has shown to limit the power density and induces dendrite formation.
Current oxide SE systems that are considered promising candidates to be employed in SSBs (e.g., garnets) require additional engineering for intimate electrode-electrolyte contact, such as co-sintering, stack pressure, etc. However, these strategies seem inadequate to maintain physical integrity given the reversible volume change of electrodes upon electrochemical cycling.
Sulfide SEs are highly conductive and easily deformable, but they suffer from limited oxidative stability, thus limiting the capacity of the SSB. While the electrochemical stability of sulfides might be extended by application of protective coatings against the cathode active material, new solid-solid coating/SE and coating/cathode interfaces are introduced, which might aggravate interface resistance and contact issues.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

An efficient Machine Learning (ML)-driven computational workflow for the design of new deformable SE materials has been devised as shown in the present disclosure.

Compounds with ML predicted hardness≤2.5 GPa (that is the calculated hardness of Li₃PS₄, here used as a reference) were computationally characterized using density-functional theory (DFT) calculations to identify thermodynamically stable compounds and to confirm their mechanical properties. Potential ionic conductor candidates were then sorted out using migration energy barriers estimated based on the empirical Bond Valence Sum method and in some cases also ab initio Molecular Dynamics (AIMD).

With the use of the computational screening described above, new deformable halide ionic conductors have been designed with good electrochemical stability against either Li metal or high voltage cathodes (or both), to be employed as anolytes or catholytes (or SEs), respectively.

Interface stability calculations show that some of the new compounds mentioned above are also chemically stable against commonly used oxide SEs, i.e., Li₇La₃Zr₂O₁₂ (LLZO), and cathodes, i.e., Li₃MnNiCoO₆ (NMC) and LiCoO₂ (LCO). The predicted chemical stability rules out side chemical reactions at the interface with such oxide phases, thus ensuring long cycle life of the SSB.

The materials in the present disclosure are newly designed deformable halide compounds (either with a new composition or with a new structure), which can be used as ionic conductors for solid-state batteries.

The materials in this disclosure are advantageous because they are newly designed compounds predicted to have favorable mechanical and (electro) chemical properties as well as high ionic conductivity.

An embodiment of the present disclosure includes an anolyte comprising a deformable halide-based ionic conductor having one of the following formulas:
CsLi₂Cl₃, wherein the CsLi₂Cl₃ has an orthorhombic crystal structure,
NaLi₃I₄,
NaLi₃Br₄,
NaLi₃Cl₄, and
KLi₂F₃.

Another embodiment includes the aforementioned anolyte, wherein the deformable halide-based ionic conductor has the formula CsLi₂Cl₃, wherein the CsLi₂Cl₃ has an orthorhombic crystal structure.

Another embodiment includes the aforementioned anolyte, wherein the deformable halide-based ionic conductor has the formula NaLi₃I₄.

Another embodiment includes the aforementioned anolyte, wherein the deformable halide-based ionic conductor has the formula NaLi₃Br₄.

Another embodiment includes the aforementioned anolyte, wherein the deformable halide-based ionic conductor has the formula NaLi₃Cl₄.

Another embodiment includes the aforementioned anolyte, wherein the deformable halide-based ionic conductor has the formula KLi₂F₃.

Another embodiment includes a solid state battery comprising an anode, a cathode, and a solid electrolyte, wherein the solid state battery comprises any aforementioned anolyte.

### BRIEF DESCRIPTION OF DRAWINGS

Example embodiments of the present disclosure will be more clearly understood from the following detailed description taken in conjunction with the accompanying drawings in which:

FIG. 1 is a graph showing the distribution of ML-predicted hardness for ˜40,000 LiX+LiX′+MX″ compositions.

FIG. 2 is a diagram showing the computational workflow for new deformable materials design.

FIG. 3 is a graph showing the ab initio Molecular Dynamics (AIMD) calculated ionic conductivity for CsLi₂Cl₃.

### DETAILED DESCRIPTION OF EXAMPLE EMBODIMENTS

The embodiments of the disclosure described herein are example embodiments, and thus, the disclosure is not limited thereto, and may be realized in various other forms. Each of the embodiments provided in the following description is not excluded from being associated with one or more features of another example or another embodiment also provided herein or not provided herein but consistent with the disclosure. For example, even if matters described in a specific example or embodiment are not described in a different example or embodiment thereto, the matters may be understood as being related to or combined with the different example or embodiment, unless otherwise mentioned in descriptions thereof. In addition, it should be understood that all descriptions of principles, aspects, examples, and embodiments of the disclosure are intended to encompass structural and functional equivalents thereof. In addition, these equivalents should be understood as including not only currently well-known equivalents but also equivalents to be developed in the future.

As used herein, expressions such as “at least one of,” when preceding a list of elements, modify the entire list of elements and do not modify the individual elements of the list. For example, the expression, “at least one of a, b and c,” should be understood as including only a, only b, only c, both a and b, both a and c, both b and c, or all of a, b and c.

An efficient Machine Learning (ML)-driven computational workflow for the design of new deformable SE materials has been devised as shown in the present disclosure.

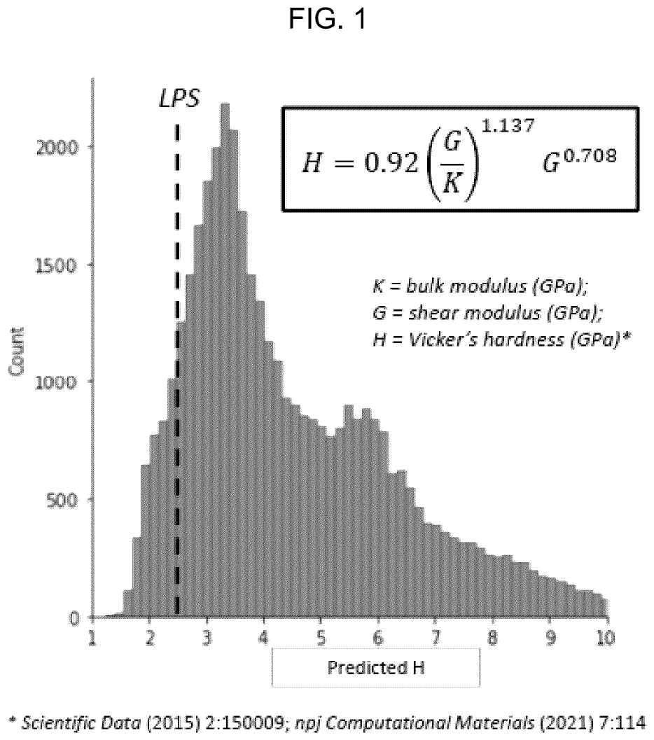

First, thousands of charge-balanced compositions by combinations of LiX and MX′ binaries were generated. LiX+LiX′+MX″ (˜40 k) and LiX+LiX′+LiX″+MX′″ (>265 k) combinations were considered, where the anion species X and X′ are chalcogenides (O²⁻, S²⁻, Se²⁻, Te²⁻), halides (Cl⁻, F⁻, Br⁻, I⁻) or pseudo-halides (BH₄⁻, BF₄⁻, AlH₄⁻, AlF₄⁻, OH⁻, SH⁻), and M is Na, Mg, Al, K, Ca, Sc, Ti, Cu, Zn, Ga, Rb, Sr, Y, Zr, Nb, Mo, Pd, Ag, Cd, In, Sn, Cs, Ba, La, Ce, Nd, Hf, Ta, W, Pt, Au, Hg, Tl, Pb, Bi. In this regard, FIG. 1 is a graph showing the distribution of ML-predicted hardness for ˜40 k LiX+LiX′+MX″ compositions.

Then, the hardness of all generated compositions was predicted using a ML model trained exclusively on compositional features and selected compositions with predicted hardness<=2.5 GPa, that is the hardness of Li₃PS₄, used as reference material for good deformability.

Structures for the selected compositions were generated by mapping onto ˜1100 prototype crystal structures from the public database AFLOW [Comp. Mat. Sci. 136, S1-S828 (2017), Comp. Mat. Sci. 161, S1-S1011 (2019), Comp. Mat. Sci. 199, 110450 (2021)]. The obtained compounds were then optimized by DFT relaxation and computationally characterized regarding thermodynamic and electrochemical stability, mechanical deformability (DFT computed hardness) and ionic conductivity (energy barriers for ionic migration estimated on the basis of the empirical Bond Valence Sum method). For some promising candidates, the conductivity was also calculated by ab initio Molecular Dynamics (AIMD).

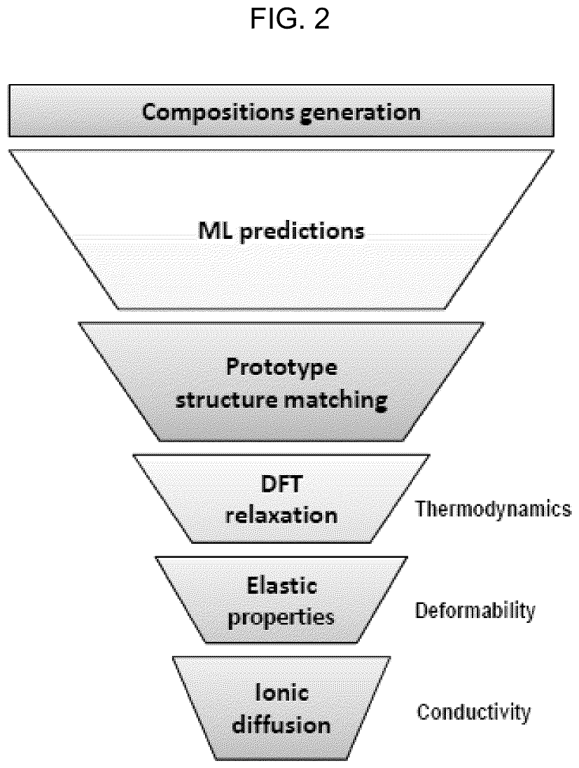

That is, compounds with ML predicted hardness<=2.5 GPa (that is the hardness of Li₃PS₄, here used as a reference) were computationally characterized using DFT calculations to identify thermodynamically stable compounds and to confirm their mechanical properties. Potential ionic conductor candidates were then sorted out using the estimated migration energy barriers and in some cases also ab initio Molecular Dynamics (AIMD). The computational workflow for new deformable materials design is shown in FIG. 2.

With the use of the computational screening described above, 5 new deformable halide ionic conductors have been designed with good electrochemical stability against Li metal, to be employed as anolytes in SSBs.

Among these 5 newly designed halide ionic conductors, some are also predicted to have wide voltage stability windows (>4V) and are therefore potentially usable also as SE separators and/or catholytes.

Interface stability calculations show that some of the 5 new compounds of the present disclosure are also chemically stable against commonly used oxide SEs, i.e., Li₇La₃Zr₂O₁₂ (LLZO), and cathodes, i.e. Li₃MnNiCoO₆ (NMC) and LiCoO₂ (LCO). The predicted chemical stability rules out side chemical reactions at the interface with such oxide phases, thus ensuring long cycle life of the SSB.

Embodiments of the deformable halide ionic conductors of the present disclosure can be made using a standard solid-state method for making halides (e.g., in an air free environment). In this method, precursor powders are combined in a certain ratio depending on the composition of the target material. In a typical preparation, precursors may consist of a lithium halide (e.g., lithium chloride) and at least one other metal halide precursor, such as a metal fluoride, metal bromide, metal iodide, or metal chloride (e.g., silver chloride).

The precursor mixture may be mixed by a method such as ball milling or planetary milling to produce a homogeneous mixture. Mixing may be done with a suitable solvent such as ethanol, isopropanol, ethylene glycol, or acetone to assist with the uniform dispersion of the precursors.

The precursor mixture may then be heat treated to an appropriate temperature for an appropriate period of time to produce a halide powder with the desired composition and crystal structure.

Subsequently the halide powder may be compressed using a hydraulic uniaxial press to form a densely packed pellet. Heat treatment may then be applied at an appropriate temperature for an appropriate period of time to produce a dense pellet which may be used as, e.g., an anolyte in a solid state lithium battery cell.

### EXAMPLES

Embodiments will now be illustrated by way of the following examples, which do not limit the embodiments in any way.

With the use of the computational screening described above, new deformable halide ionic conductors have been designed with good electrochemical stability against Li metal and, in some cases, also against high voltage cathodes, to be employed as anolytes or catholytes (or SEs), respectively.

Interface stability calculations show that some of the new compounds of the present disclosure are also chemically stable against commonly used oxide SEs, i.e., Li₇La₃Zr₂O₁₂ (LLZO). The predicted chemical stability rules out side chemical reactions at the interface with such oxide phases, thus ensuring long cycle life of the SSB.

Table 1 set forth below shows new deformable ionic conductors designed with the computational workflow described in the present disclosure. The screening criteria were Eₕᵤₗₗ≤30 meV/atom (thermodynamic stability), hardness≤2.5 GPa, energy barrier for ionic migration≤0.5 eV, and absence from Materials Project database of compounds with either the same composition or the same structure (or both).

TABLE 1
New deformable ionic conductors

| | | | | | | | | Ion- |
|---|---|---|---|---|---|---|---|---|
| | | | | | | | | migration |
| | | | Space | | | | | Energy |
| | | Crystal | group | Eₕᵤₗₗ | Reduction | Oxidation | Hardness | barrier |
| | Formula | system | symbol | (meV/atom) | Voltage | Voltage | (GPa) | (eV) |
| 0 | CsLi2Cl3 | orthorhombic | Cmcm | 9 | 0.00 | 4.34 | 1.352 | 0.413 |
| 1 | NaLi3I4 | orthorhombic | Pmn2_1 | 13 | 0.05 | 2.55 | 0.537 | 0.314 |
| 2 | NaLi3Br4 | orthorhombic | Pmn2_1 | 16 | 0.05 | 3.25 | 0.876 | 0.273 |
| 3 | NaLi3Cl4 | orthorhombic | Pmn2_1 | 18 | 0.05 | 3.85 | 0.989 | 0.270 |
| 4 | KLi2F3 | orthorhombic | Pnma | 20 | 0.45 | 5.85 | 1.497 | 0.411 |

The following observations can be made from the aforementioned new deformable ionic conductors designed with the computational workflow described in the present disclosure.

All of the newly designed compounds are halides, including chlorides and fluorides.

CsLi₂Cl₃, NaLi₃I₄, NaLi₃Br₄ and NaLi₃Cl₄ are electrochemically stable vs. Li metal (red_volt≈0V) and therefore usable as anolytes.

KLi₂F₃ is also stable down to 0.45V vs. Li/Li+ and might therefore be kinetically stabilized as anolyte vs. Li metal anode.

CsLi₂Cl₃ and KLi₂F₃ are also stable at high voltage (oxi_volt=4.34V and 5.85V vs. Li/Li+), and can therefore be used also as SE separators and/or catholytes in the SSB.

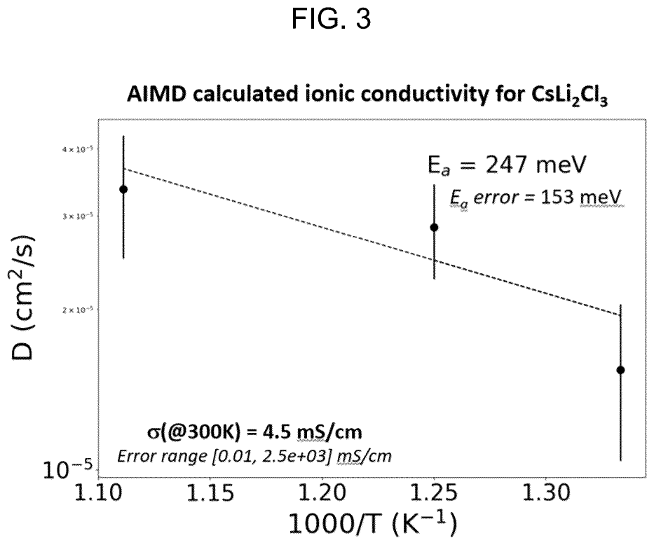

In regard to CsLi₂Cl₃, FIG. 3 is a graph showing the ab initio Molecular Dynamics (AIMD) calculated ionic conductivity for CsLi₂Cl₃.

All compounds with low valence M cations are thermodynamically stable or have very low reaction energies (indicating low driving force for reaction) against oxides like LLZO, LCO and NMC (see Tables 2-4).

TABLE 2
Predicted interface reactions against Li7La3Zr2O12 (LLZO)

| | | | Reaction |
|---|---|---|---|
| | | | energy |
| | Formula | Reaction vs. LLZO | (eV/atom) |
| 0 | CsLi2Cl3 | — | — |
| 1 | NaLi3I4 | 0.5 Li7La3Zr2O12 + 0.5 NaLi3I4 −> 0.5 | −0.015 |
| | | Li6Zr2O7 + 0.5 NaI + Li2O + 1.5 LaIO | — |
| 2 | NaLi3Br4 | — | — |
| 3 | NaLi3Cl4 | — | — |
| 4 | KLi2F3 | — | — |

TABLE 3
Predicted interface reaction against Li3MnCoNiO6 (NMC)

| | | | Reaction |
|---|---|---|---|
| | | | energy |
| | Formula | Reaction vs. NMC | (eV/atom) |
| 0 | CsLi2Cl3 | — | — |
| 1 | NaLi3I4 | — | — |
| 2 | NaLi3Br4 | — | — |
| 3 | NaLi3Cl4 | — | — |
| 4 | KLi2F3 | — | — |

TABLE 4
Predicted interface reactions against LiCoO2 (LCO)

| | | | Reaction |
|---|---|---|---|
| | | | energy |
| | Formula | Reaction vs. LCO | (eV/atom) |
| 0 | CsLi2Cl3 | — | — |
| 1 | NaLi3I4 | — | — |
| 2 | NaLi3Br4 | — | — |
| 3 | NaLi3Cl4 | — | — |
| 4 | KLi2F3 | — | — |

Thus, Tables 2-4 show the computed interface stability against oxides commonly used in SSBs, namely LLZO (SE), LCO and NMC (cathodes).

As shown above, predicted reaction energies (e_rxn) are generally low or null for compounds with low valence metals, namely, Cs⁺, Na⁺, and K⁺. In this regard, the dash in the tables means null, which is no reaction.

The foregoing is illustrative of exemplary embodiments and is not to be construed as limiting the disclosure. Although a few exemplary embodiments have been described, those skilled in the art will readily appreciate that many modifications are possible in the above embodiments without materially departing from the disclosure.

What is claimed is:

1. An anolyte comprising a deformable halide-based ionic conductor having one of the following formulas:
CsLi₂Cl₃, wherein the CsLi₂Cl₃ has an orthorhombic crystal structure,
NaLi₃I₄,
NaLi₃Br₄,
NaLi₃Cl₄, and
KLi₂F₃.

2. The anolyte according to claim 1, wherein the deformable halide-based ionic conductor has the formula CsLi₂Cl₃, wherein the CsLi₂Cl₃ has an orthorhombic crystal structure.

3. The anolyte according to claim 1, wherein the deformable halide-based ionic conductor has the formula NaLi₃I₄.

4. The anolyte according to claim 1, wherein the deformable halide-based ionic conductor has the formula NaLi₃Br₄.

5. The anolyte according to claim 1, wherein the deformable halide-based ionic conductor has the formula NaLi₃Cl₄.

6. The anolyte according to claim 1, wherein the deformable halide-based ionic conductor has the formula KLi₂F₃.

7. A solid state battery comprising an anode, a cathode, and a solid electrolyte, wherein the solid state battery comprises an anolyte according to claim 1.

8. A solid state battery comprising an anode, a cathode, and a solid electrolyte, wherein the solid state battery comprises an anolyte according to claim 2.

9. A solid state battery comprising an anode, a cathode, and a solid electrolyte, wherein the solid state battery comprises an anolyte according to claim 3.

10. A solid state battery comprising an anode, a cathode, and a solid electrolyte, wherein the solid state battery comprises an anolyte according to claim 4.

11. A solid state battery comprising an anode, a cathode, and a solid electrolyte, wherein the solid state battery comprises an anolyte according to claim 5.

12. A solid state battery comprising an anode, a cathode, and a solid electrolyte, wherein the solid state battery comprises an anolyte according to claim 6.
